(19) United States
(12) Patent Application Publication
(10) Pub. No.: US 2021/0331796 A1
(43) Pub. Date: Oct. 28, 2021

(54) AMPHIBIOUS, PRESSURIZABLE AND LOW NOISE TWIN-ENGINE AIRCRAFT CONFIGURATION

(71) Applicant: MAD AEROSPACE CORP., Shefford (CA)

(72) Inventor: Antoine MOREAU, Shefford (CA)

(21) Appl. No.: 16/613,896

(22) PCT Filed: Apr. 24, 2018
(86) PCT No.: PCT/CA2018/050483

§ 371 Date: Nov. 15, 2019

Related U.S. Application Data
(60) Provisional application No. 62/602,973, filed on May 15, 2017.

(51) Int. Cl. B64C 35/00; B64C 5/00; B64C 1/06; B64C 1/16; B64C 11/46; B64C 1/14; B64D 27/02; B64C 9/00; B64C 1/00; B64C 1/10; B64C 3/18; B64C 3/16; B64C 25/54

(52) U.S. Cl. CPC B64C 35/008; B64C 25/54; B64C 1/068; B64C 1/16; B64C 11/46; B64C 1/1423; B64D 27/02; B64C 1/1415; B64C 9/00; B64C 1/1484; B64C 1/0009; B64C 1/10; B64C 3/185; B64C 3/16; B64C 5/00

(57) ABSTRACT

A low noise aircraft comprising a fuselage comprising a nose section, a cabin and a tail comprising an empennage, the profile of the fuselage tightening towards the tail, two wings mounted on opposite sides of the fuselage, two engines, each engine mounted on a pylon on a respective side of the fuselage, two propellers, each propeller joined to and positioned behind a respective the engine, at least one cabin door to access the cabin, and landing gear, wherein the engines are positioned above the wings, wherein the propellers are positioned at a rear end of each engine such that the propellers push the engines, and wherein the propellers are positioned behind the inhabitable zone of the cabin.

### CROSS REFERENCE TO RELATED APPLICATIONS

This application claims the benefits of U.S. provisional application Ser. No. 62/602,973, filed on May 15, 2017, which is incorporated herein by reference in its entirety.

### FIELD OF THE INVENTION

The present invention relates to aircraft design. Specifically, the present invention relates to an amphibious, pressurizable and low noise twin-engine aircraft configuration

### BACKGROUND OF THE INVENTION

Typical aircraft engines and propellers produce significant sound during operation, disturbing passengers in the cabin as well as over-flown communities on the ground. Further, due to their placement, engines, propellers and wings can impair pilot and passengers visibility. Additionally, typical aircraft noses include a fixed window, with somewhat limited view for pilots, and in some cases a luggage compartment only accessible from the outside. Another issue in general aviation is that turbulence, vibrations and gusts may cause abrupt jolts during flights, rendering the passengers uncomfortable. In addition, most current aircrafts suffer a loss of control authority and reduced maneuvering capacity at lower flight speeds.

In the current art, an aircraft design needs to undergo several modifications in order to adapt to various circumstances such as different uses or powering systems.

In the event of engine failure, most twin-engine aircrafts suffer an immediate and aggressive tendency to yaw and roll due to the resulting off-centre thrust force, along with a large reduction in flight speed and climbing capabilities. Controlling the aircraft becomes hazardous, problematic and demanding to the pilot, resulting in obvious safety issues. Further, most twin-engine aircrafts with wing-mounted engines become very hard to control if the flight speed drops below a minimal control speed (V_{MC}). For such aircrafts, the V_{MC} is higher than the stall speed in landing configuration (Vs₀), forcing the aircraft to land at higher velocities which causes safety issues.

An amphibious aircraft is an aircraft that can take off and land on both land and water. In the current art, amphibious aircraft design involves making a choice between a low “float wings” configuration that does not require wing-mounted floats but does not allow for the use of flaps, and a “higher wings” configuration that includes flaps but requires wing-mounted floats. Further, most current pressurized amphibious aircrafts are quite heavy, often weighing over 6000 pounds.

### SUMMARY OF THE INVENTION

According to the present invention, there is provided a low noise aircraft comprising a fuselage comprising a nose section, a cabin and a tail comprising an empennage, the profile of the fuselage tightening towards the tail, two wings mounted on opposite sides of the fuselage, two engines, each engine mounted on a pylon on a respective side of the fuselage, two propellers, each propeller joined to and positioned behind a respective the engine, at least one cabin door to access the cabin, and landing gear, wherein the engines are positioned above the wings, wherein the propellers are positioned at a rear end of each engine such that the propellers push the engines, and wherein the propellers are positioned behind the inhabitable zone of the cabin.

In an embodiment, the fuselage is configured to receive a boat hull, such that the aircraft is amphibious.

In an embodiment, the wings are immersible in water.

In an embodiment, the geometry of the fuselage comprises a plurality of circular arcs meeting at structurally reinforced pillars and beams, such that the cabin is pressurizable.

In an embodiment, the fuselage further comprises a luggage compartment in the tail and a luggage compartment door to access the luggage compartment.

In an embodiment, the empennage comprises one of a “T” tail configuration, a “U” tail configuration, a “V” tail configuration, an “H” tail configuration and a “+” cruciform tail configuration.

In an embodiment, the thrust of the engines is oriented inward toward the control surfaces of the empennage.

In an embodiment, the thrust of the engines is oriented downward toward the empennage.

In an embodiment, the exhaust of the engines is directed at least one of outboard and upward relative to the cabin.

In an embodiment, the engines are one of internal combustion engines, turboprop engines, turbofan engines and electrical motors.

In an embodiment, the pylons are aerodynamically profiled and contribute to the aircraft's lift.

In an embodiment, the landing gear comprises a tricycle landing gear comprising a nose gear and two main landing gears, wherein the tricycle landing gear can be either fixed or retractable inside the aircraft.

In an embodiment, the wings each comprise at least an inner wing section and an outer wing section, each inner wing section comprising a stronger dihedral angle than each outer wing section.

In an embodiment, the inner wing section is stiff and the outer wing section is flexible and bends during flight.

In an embodiment, each inner wing section terminates at a plurality of attachment points for the landing gear, and the fuselage further comprises landing gear compartments for storing the landing gear such that the landing gear is retractable.

In an embodiment, the landing gear compartments are watertight.

In an embodiment, the inner wing sections cross through the aircraft under at least one seat inside the cabin.

In an embodiment, the wings comprise at least one of plain flaps, single slotted flaps, double slotted flaps, fowler flaps, split flaps, slats, leading edge droops and leading edge slots.

In an embodiment, the dihedral angles of the inner wing sections are strong enough such that that the outer wing sections stay above the water.

In an embodiment, the inner wing sections comprise at least one of floats and sponsons.

In an embodiment, the outer wing sections comprise floats.

In an embodiment, the tip of each wing comprises at least one drag reduction device.

In an embodiment, the drag reduction device is one of a winglet, an end plate, a booster wingtip, a Hoerner wingtip and a raked wingtip.

In an embodiment, each at least one cabin door comprises an upper section that opens upward in a “Gull Door” configuration and a lower section that opens downward, wherein the lower section acts as an entry step when opened.

In an embodiment, the at least one upper door section and the at least one lower door section comprise semi-circular geometries and are reinforced using at least one of pillars, beams, stiffeners or ribs, such that the cabin is pressurizable.

In an embodiment, the cutouts for the at least one lower door section are waterproof.

In an embodiment, the luggage compartment door is openable upward and the opening for the luggage compartment door is above water level.

In an embodiment, a usable space is created in the floor of the cabin at the level where the wings are attached to the fuselage.

In an embodiment, at least one seat is foldable and storable in the usable space.

In an embodiment, a bed is foldable and storable in the usable space.

In an embodiment, a sanitation system such as a lavatory or a portable toilet is storable in the usable space.

In an embodiment, the necessary systems to perform medical transport missions, such as an oxygen system, a pressurized air system, a vacuum system and an AC power supply system is storable in the usable space.

In an embodiment, the cabin further comprising at least four seats, wherein the front and middle row seats are turnable in all directions to face back or sideways in order to create a living room layout, and wherein the seats that are adjacent to the cabin door are turnable towards the door to allow for fishing or to facilitate the installation of a baby seat from the outside of the aircraft.

In an embodiment, the cabin further comprising at least four seats, wherein two tandem seating positions are replaceable by a single size bed.

In an embodiment, the single size bed is mountable on a rail system allowing the bed or stretcher to slide and rotate through the door and toward the outside of the aircraft to facilitate loading or unloading of an injured person during medical transport missions.

In an embodiment, a nose section of the fuselage comprises an open empty space.

In an embodiment, the aircraft comprises an elongated front windshield comprising a front access door that opens upwards such that the nose section and the open empty space are accessible to passengers for entertainment, sport and aircraft entry and exit.

In an embodiment, the aircraft comprises a fixed front windshield and the open empty space is usable for luggage and equipment storage, the cabin comprising an access door to the open empty space.

In an embodiment, the fuselage is aerodynamically profiled such that lift is generated over the nose section and the cabin.

In an embodiment, a central beam at the rear of the cabin descends from the ceiling to the floor to reinforce the aft pressure bulkhead and to create a structural bridge between the rear spar of the wings and the upper frame of the fuselage that links to the pylons.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, wherein:

FIG. 1A-1D show respective isometric, top, front and side schematic views of a low noise twin-engine aircraft, in accordance with an illustrative embodiment of the present invention;

FIG. 2 shows a front cutaway schematic view of the cabin of a low noise twin-engine aircraft enterable by users from both ground and water, in accordance with an illustrative embodiment of the present invention;

FIG. 3 shows a front cutaway schematic view of the luggage compartment of a low noise twin-engine aircraft accessible from both ground and water, in accordance with an illustrative embodiment of the present invention;

FIG. 4 shows a side cutaway schematic view of a low noise twin-engine aircraft accessible from the nose of the aircraft, in accordance with an illustrative embodiment of the present invention;

FIG. 5 shows a side cutaway schematic view of a low noise twin-engine aircraft with an empty space in the nose of the aircraft, in accordance with an illustrative embodiment of the present invention;

FIG. 6 shows a front schematic view of the wings of a low noise twin-engine aircraft, in accordance with an illustrative embodiment of the present invention;

FIG. 7 shows a side cutaway schematic view of various seating configurations for a low noise twin-engine aircraft, in accordance with an illustrative embodiment of the present invention;

FIG. 8 shows a top cutaway view of various seating configurations for a low noise twin-engine aircraft, in accordance with an illustrative embodiment of the present invention; and

FIG. 9 shows a side cutaway view of the various sections a low noise twin-engine aircraft, in accordance with an illustrative embodiment of the present invention.

### DETAILED DESCRIPTION OF THE INVENTION

With reference to the annexed drawings the preferred embodiments of the present invention will be herein described for indicative purpose and by no means as of limitation with like numerals of reference being employed for like parts in differing embodiments of the invention or its details.

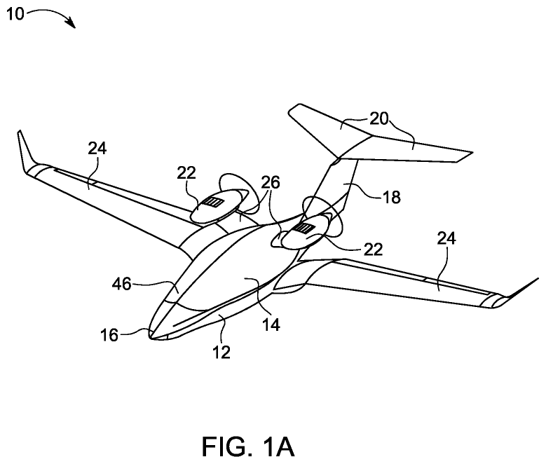

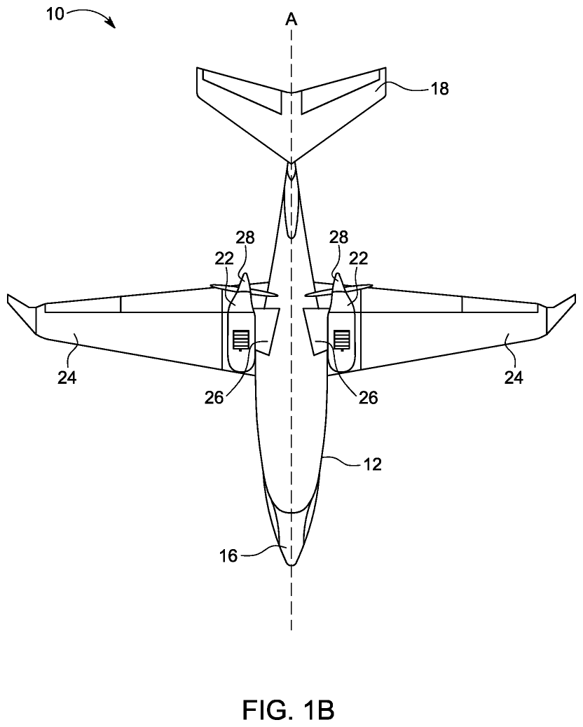

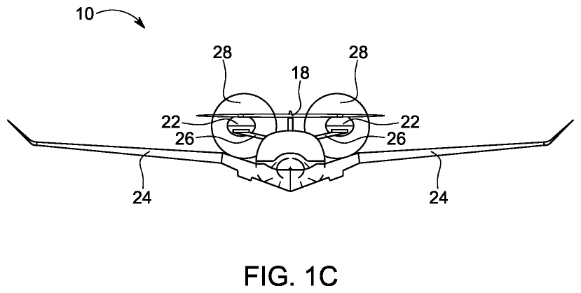

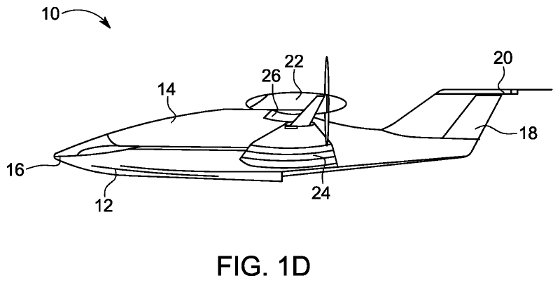

Referring first to FIG. 1A-1D, there is shown a low noise twin-engine aircraft, generally referred to by the reference numeral 10. Aircraft 10 comprises a fuselage 12 comprising a cabin 14 and a nose section 16 at the front of the fuselage 12, and is terminated by a tail 18. Tail 18 comprises an empennage 20 illustratively shown with a “T” tail configuration, but may be alternatively configured as, for example, a “V” tail, a “U” tail, an “H” tail or a “+” cruciform tail empennage 20. Engines 22 and wings 24 extend and protrude from each side of fuselage 12, as will be discussed in further detail below. While the engines 22 in FIG. 1A-1D are illustratively internal combustion engines, aircraft 10 is configurable to comprise a plurality of powering options such as turboprop engines, turbofans, and electric motors. As engines 22 are positioned near the center of gravity of the aircraft 10, the aircraft can be easily re-engineered to accommodate different powering options without affecting its center of gravity.

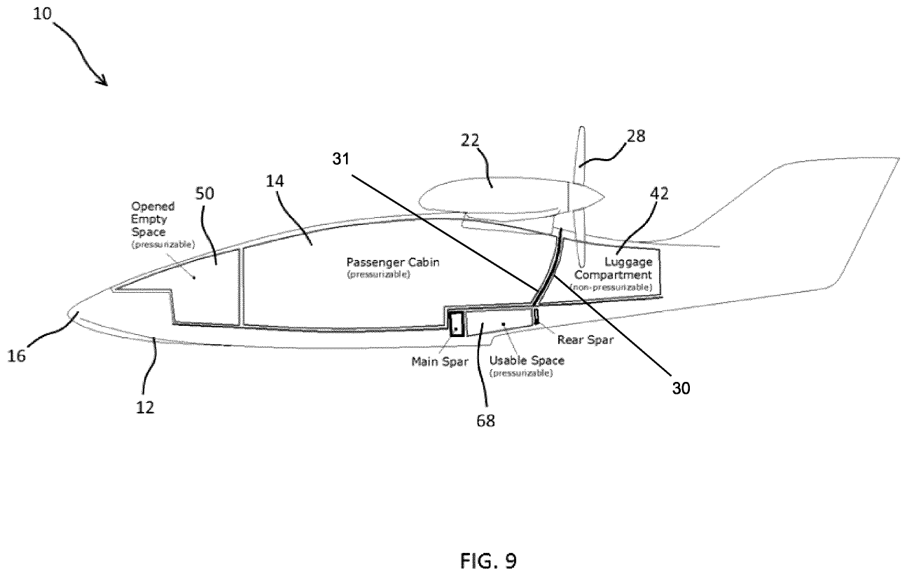

Still referring to FIG. 1A-1D, the engines 22 are located above the wings 24 and mounted on pylons 26 on each side of the cabin 14 such that the thrust emanates closely to the centerline A of the aircraft 10, thus improving controllability in the event of an engine failure. In an embodiment, pylons 26 are aerodynamically profiled and contribute to the aircraft's 10 lift. The aircraft's low-mid wing design comprising pylon 26-mounted engines 22 over the wings 24 is advantageous for the general aircraft category of less than roughly 6000 pounds, although in various embodiments the design may be scaled up for larger aircrafts. Engines 22 may comprise propellers 28 arranged in a “pusher” configuration. As a person of ordinary skill in the art would understand, in a “pusher” configuration, each propeller 28 is positioned behind a respective engine 22 such that the propeller 28 pushes or propels the engine 22, and thus the aircraft 10, forward. Further, in an embodiment, wings 24 may act as noise shields for the engines 22 and propellers 28 located above each wing 24, thus reducing aircraft 10 noise on the ground and also protecting the propellers 28 from water splashing thereon. In addition, as the engines 22 and propellers 28 are positioned at the rear of the cabin 14 behind the pressurizable zone of the cabin 14 (as seen in FIG. 9), the noise levels inside the cabin 14 are reduced and passengers inside the cabin 14 are protected in the case of a propeller blade breakage. Further, the position of the engines 22 ensures that passengers inside the cabin 14 have a wide field of vision. Exhaust from the engines 22 may be directed outboard and upward, thus reducing the noise in the cabin 14 and on the ground. In an embodiment, thrust or “prop-wash” from the engines 22 is tilted inward or “toe-in” towards the tail 18 and downward to blow on the aircraft's 10 control surfaces, thus providing good control authority and preserving both elevator and rudder authority, even at lower speeds. Thus, in the event of an engine 22 failure, the remaining operational engine 22 will continue to expel thrust on the control surfaces and the pilot will maintain control authority. In such an event, the aircraft 10 is not subjected to a minimal control speed (V_{MC}) as would traditional twin-engine aircrafts, and thus remains controllable all the way to the stall speed.

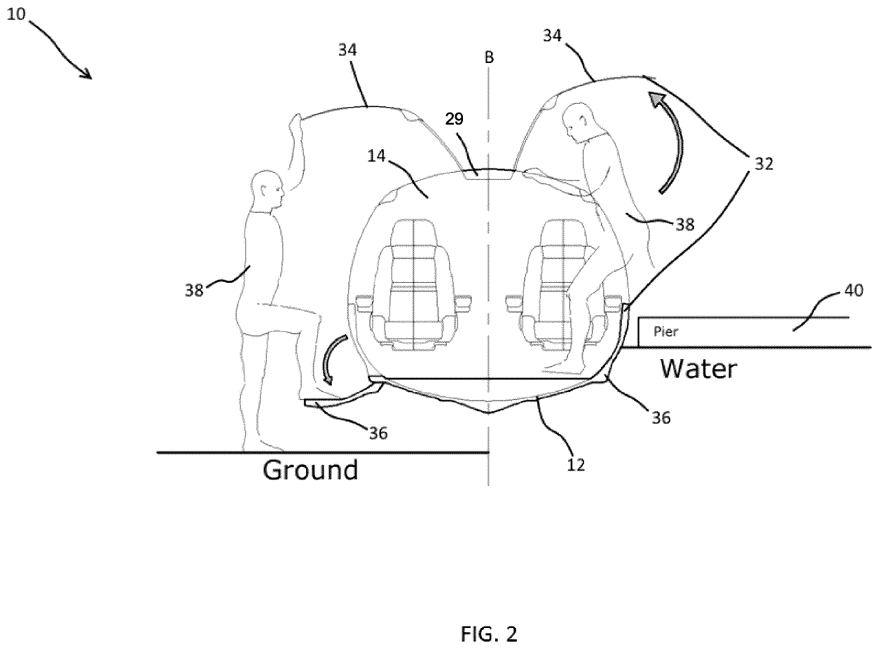

Referring now to FIG. 2 in addition to FIGS. 1B and 1D, the silhouette of the fuselage 12 tightens at the back of the cabin 14 in a tadpole-like shape, thus the propellers 28 are positionable close to center line A of the aircraft 10. This configuration is advantageous in the case of an engine 22 failure, as the aircraft's 10 natural yawing and rolling tendency induced by off-centre thrust is minimized and aircraft 10 will remain easily pilotable. In an embodiment, the geometry of the underside of the fuselage 12 is configured to receive a boat hull without necessitating any additional modifications to the layout of the structure of the aircraft 10, thus allowing the aircraft 10 to be amphibious, capable of landing on both water and land. As aircraft 10 is easily adaptable, in various embodiments the aircraft 10 can serve a plurality of purposes, including but not limited to a corporate plane, a bush plane, a medical transport plane, a cargo plane, and, as discussed throughout the present disclosure, an amphibious plane.

Still referring to FIG. 2 in addition to FIGS. 1B and 1D, in an embodiment, the geometry of the fuselage 12 is composed of a plurality of circular arcs meeting at structurally reinforced pillars and beams 29, thus allowing for pressurization of the cabin 14. In an embodiment, the fuselage 12 of the aircraft 10 is pressurizable, the pressurizing loads being evenly distributed in tension within the cabin's 14 walls and transferred to its frame. In an embodiment, a central beam 30 (shown in FIG. 9) at the rear of the cabin 14 descends from the ceiling to the floor to reinforce the aft pressure bulkhead 31 and to create a structural bridge between the rear spar of the wings 24 and the upper frame of the fuselage 12 that links to the pylons. Aircraft 10 further comprises a plurality of side cabin doors 32 providing access to the cabin 14. In an embodiment, each door comprises both an upper section 34 and lower section 36. In this embodiment, when the aircraft 10 lands on the ground, both the upper section 34 and the lower section 36 are opened, the lower section 36 acting as a step for passengers 38 to use upon entry into the cabin 14. When then aircraft 10 lands on water, only the upper section 34 of each side cabin door 32 opens while the lower section 36 is part of the hull of the fuselage 12 and may be partially submerged. As such, a passenger 38 would typically access the cabin 14 via a pier 40 in the water, thus negating the need for a step.

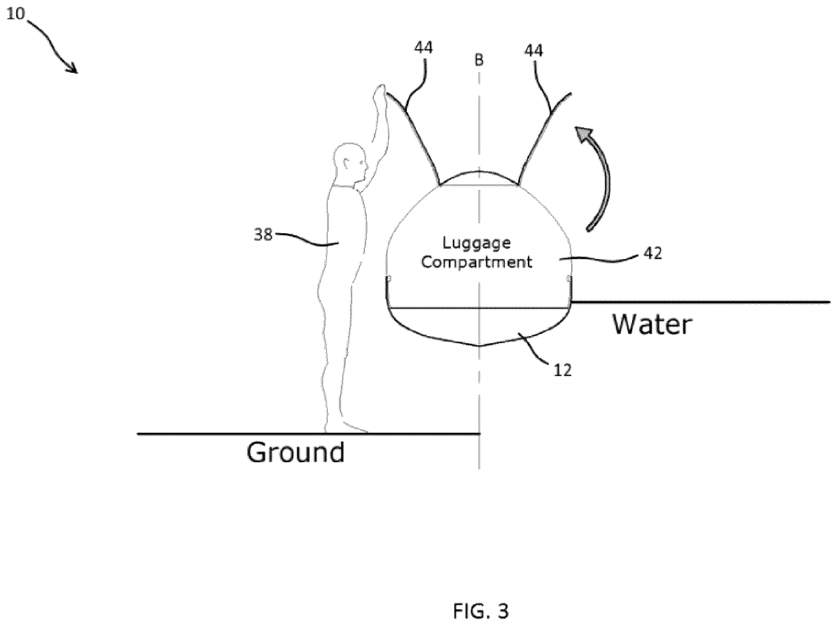

Referring additionally to FIG. 3, aircraft 10 comprises a plurality of primary luggage compartment 42 accessible via one or more primary luggage compartment doors 44. In the amphibious embodiment of the aircraft 10, primary luggage compartment doors 44 are configured to sit higher than the water level such that they are openable without letting any water inside the cabin 14. Preferably, the luggage compartments 42 are not connected to the cabin 14. Side cabin doors 32 and primary luggage compartment doors 44 open by vertically rotating the doors 32, 44 relative to vertical axis B.

Referring back to FIG. 1A, fuselage 12 is profiled so as to generate lift over its nose 16 and cabin 14 areas, which pulls the aircraft's 10 nose section 16 upward, thus helping to balance the natural pitching moment of the wings 24, which in turn stabilizes the aircraft 10. Aircraft 10 may comprise a large front windshield 46 to enhance the pilot's visibility. As an example, even near a stall angle of attack, in an embodiment the windshield 46 would be large enough to allow the pilot to look downward.

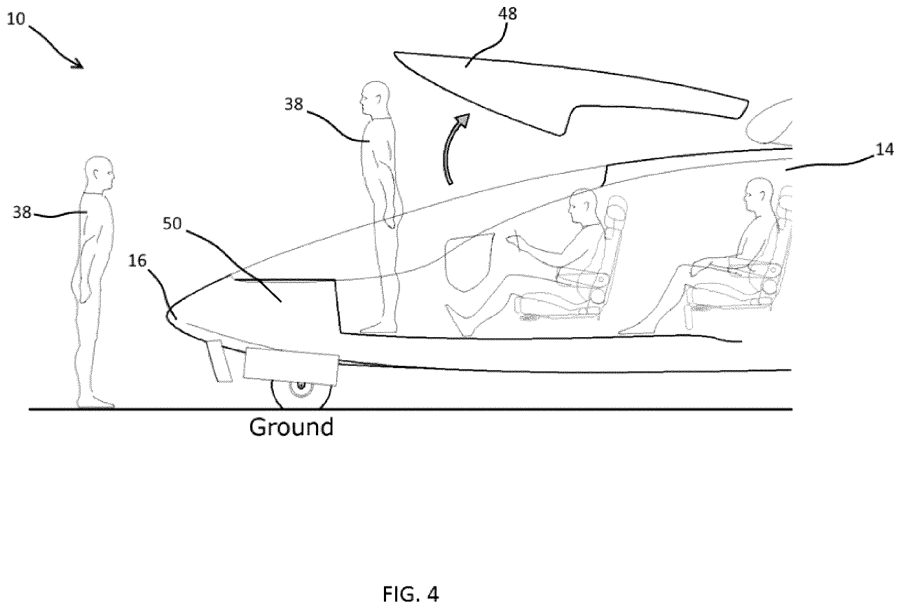

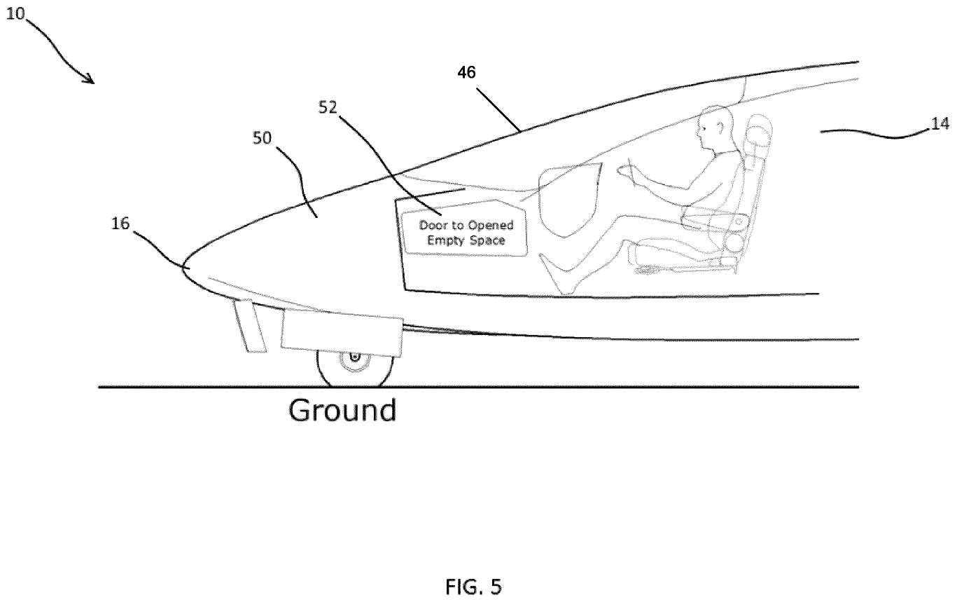

Referring now to FIG. 4, in an embodiment, the aircraft 10 comprises a front access door 48 allowing passengers 38 to enter and exit the aircraft 10 from the nose section 16 when the aircraft 10 is, for example, docked or beached. The aircraft 10 may further comprise an open empty space 50 at the nose section 16 allowing passengers 38 access to the nose section 16 for entertainment purposes or to practice sports such as fishing when the aircraft 10 is on water. Referring now to FIG. 5, in an alternate embodiment, the empty space 50 in the nose section 16 may be configured for storing luggage. In this embodiment, a door 52 to the empty space 50 is provided at the front of the cabin 14. By storing luggage in empty space 50, the center of gravity of the aircraft 10 may be intelligently balanced by proper mass distribution.

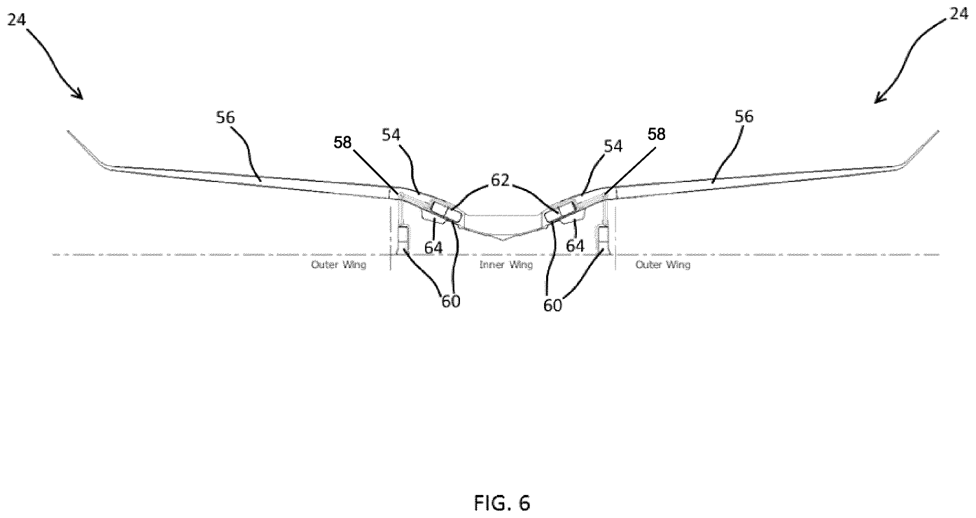

Referring now to FIG. 6 in addition to FIG. 1A-1D, wings 24 may adopt a “Gull Wing” configuration with a prominent bend towards the center of the aircraft 10. Each wing 24 comprises a rigid inner wing 54 and a flexible outer wing 56, and as such is designed like a bow. The structure of each inner wing 54 crosses through the aircraft 10 under the seats (not shown) and proceeds to the attachment points 58 of the landing gear 60, which retracts and is stored in landing gear compartments 62 during flight. In the aircraft's 10 amphibious embodiment, each landing gear compartment 62 is watertight. In an embodiment, the landing gear (60) comprises a nose gear and two main landing gears. From the side of the fuselage 12 to its limits, each inner wing 54 has a strong dihedral angle to ensure that the outer wings 56 rise above water in the amphibious embodiment of the aircraft 10. In such an embodiment, the inner wings 54 are immersible in water and may have a sponson float 64 added under them. The inner wings 54 are configured to be rigid and robust. The bow-like structure of the wings 24 allow the wings 24 to bend during flight to increase passenger comfort inside the cabin 14, while being stiff in the center for rigid installation of the landing gear 60. In addition, in the amphibious embodiment of the aircraft 10, the multi-section wing design allows the inner wings 54 to act as float wings. In an embodiment, the outer wings 56 may incorporate high lift devices (not shown) such as plain flaps, single slotted flaps, double slotted flaps, fowler flaps, split flaps, slats, leading edge droops, and leading edge slots.

Still referring to FIG. 6 in addition to FIG. 1A-1D, each outer wing 56 is thinner and more flexible than the inner wings 54, which allows for bending, which increases the comfort of passengers inside the cabin 14. Each outer wing 56 may be made of less rigid materials than the inner wings 54. The dihedral angles of the outer wings 56 are smaller than those of the inner wings. Each outer wing 56 may be equipped with flaps, ailerons, slats, and winglets (not shown). In the amphibious embodiment of the aircraft 10, the inner wings 54 and outer wings 56 are immersible in water, while the tips of the wings 24 remain out of the water, even in the presence of large waves. The tip of each wing (24) may comprise a drag reduction device (not shown) such as a winglet, an end plate, a booster wingtip, a Hoerner wingtip and a raked wingtip.

Still referring to FIG. 6 in addition to FIG. 1A-1D, the twist (or washout) and aerodynamic profiles of each wing 24 are configured in order to obtain a favourable span-wise lift distribution that is optimized to take into account the increase in speed due to the propeller's 28 air suction. Further, the twist (or washout) and aerodynamic profiles of each wing 24 are configured in order to obtain a favourable span-wise lift distribution that is optimized to take into account the circulation induced by the air rotation of the propellers 28, which induces an upward velocity vector (upwash) on each wing 24 and allows for a reduction of the lift-induced drag.

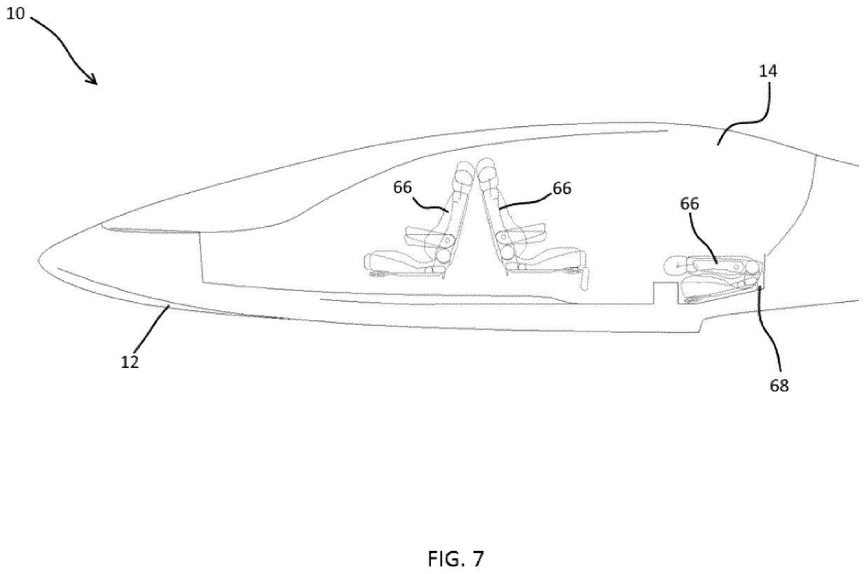

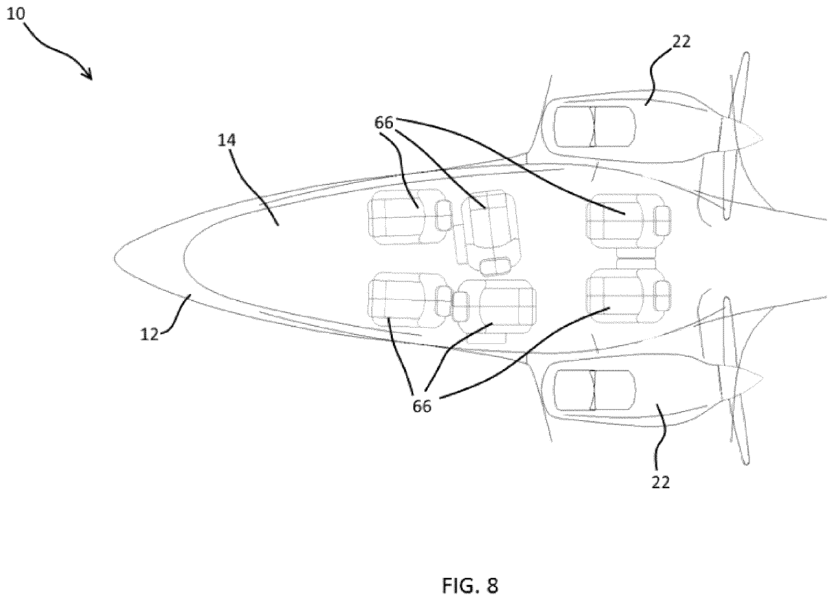

Referring now to FIG. 7-8 in addition to FIG. 1A, various seating configurations in the cabin 14 are shown. The cabin comprises a row of seats 66 located at the level of the wings 24 that can be folded into a usable space 68 in the floor of the aircraft 10 to create added space for cargo or luggage. In an embodiment in which the aircraft 10 comprises four or more seats 66, as illustratively shown in FIG. 8, the front and middle row seats 66 may be turned in all directions to face back or sideways in order to create a living room-style layout. Further, the seats 66 that are adjacent to a door may be turned towards the door to allow for activities such as fishing when the aircraft 10 is amphibious and on water, or to facilitate the installation of a baby seat (not shown) from the outside of the aircraft 10. In an embodiment, aircraft 10 may be designed to have a seating capacity between one and twelve seats 66, although such numbers are not limitative and the design could be configured for unmanned aerial vehicles or larger aircraft.

Referring now to FIG. 9, in an embodiment, various chambers of the aircraft 10 are pressurizable. The cabin 14, the usable space 68 inside the cabin and the open empty space 50 may be pressurized, while the primary luggage compartment 42 may not be pressurized. In various embodiments, aircraft 10 is highly personalizable depending on individual needs, including or excluding options such as but not limited to a boat hull to make the aircraft 10 amphibious, retractable landing gears 60, pressurized cabin 14, de-icing system, doors on both sides, openable nose compartment, a folding bed or rear seats that can be folded and stored inside the cabin floor, a lavatory, long range fuel tanks, and combinations of the above. In various embodiments, the usable space 68 may store a sanitation system such as a lavatory or a toilet inside the floor of the cabin 14. In the embodiment where aircraft 10 is used for medical transportation purposes, usable space 68 may be used to install the necessary systems to perform such medical transport missions, such as an oxygen system, a pressurized air system, a vacuum system, and a AC power supply system.

Although the present invention of a multi-reservoir feeding/dosing apparatus has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A low noise aircraft (10) comprising:
a fuselage (12) comprising a nose section (16), a cabin (14) and a tail (18) comprising an empennage (20), the profile of said fuselage (12) tightening towards said tail (18);
two wings (24) mounted on opposite sides of said fuselage (12);
two engines (22), each said engine (22) mounted on a pylon (26) on a respective side of said fuselage (12);
two propellers (28), each said propeller (28) joined to and positioned behind a respective said engine (22);
at least one cabin door (32) to access said cabin (14); and
landing gear (60);
wherein said engines (22) are positioned above said wings (24);
wherein said propellers (28) are positioned at a rear end of each said engine (22) such that said propellers (28) push said engines (22);
wherein said propellers (28) are positioned behind the inhabitable zone of said cabin (14); and
wherein the thrust of said engines (22) is oriented inward toward the control surfaces of said empennage (20), or downward toward said empennage (20), or at least one of outboard and upward relative to said cabin (14).

2. (canceled)

3. (canceled)

4. The aircraft of claim 1, wherein the geometry of said fuselage (12) comprises a plurality of circular arcs meeting at structurally reinforced pillars and beams (30), such that said cabin (14) is pressurizable.

5. The aircraft of claim 1, wherein said fuselage (12) further comprises a luggage compartment (42) in said tail (18) and a luggage compartment door (44) to access said luggage compartment (42).

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The aircraft of claim 1, wherein said wings (24) comprise at least one of plain flaps, single slotted flaps, double slotted flaps, fowler flaps, split flaps, slats, leading edge droops and leading edge slots.

19. (canceled)

20. (canceled)

21. (canceled)

22. (canceled)

23. (canceled)

24. The aircraft of claim 1, wherein each said at least one cabin door (32) comprises an upper section (34) that opens upward in a “Gull Door” configuration and a lower section (36) that opens downward, wherein said lower section acts as an entry step when opened.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The aircraft of claim 1, wherein a nose section (16) of said fuselage (12) comprises an open empty space (50).

37. The aircraft of claim 36, wherein the aircraft (10) comprises an elongated front windshield (46) comprising a front access door (48) that opens upwards-and-back such that said nose section (16) and said open empty space (50) are accessible to passengers for entertainment, sport or aircraft (10) entry and exit.

38. The aircraft of claim 36, wherein the aircraft (10) comprises a fixed front windshield (46) and said open empty space (50) is usable for luggage and equipment storage, said cabin (14) comprising an access door (52) to said open empty space (50).

39. The aircraft of claim 1, wherein said fuselage (12) is aerodynamically profiled such that lift is generated over said nose section (16) and said cabin (14).

40. The aircraft of claim 1, wherein a central beam (30) at the rear of said cabin (14) descends from the ceiling to the floor to reinforce the aft pressure bulkhead (31) and to create a structural bridge between the rear spar of said wings (24) and the upper frame of said fuselage (12) that links to said pylons (26).

41. The aircraft of claim 1, wherein said propellers (28) are positioned above said wings (24).

42. A low noise aircraft (10) comprising:
a fuselage (12) comprising a nose section (16), a cabin (14) and a tail (18) comprising an empennage (20), the profile of said fuselage (12) tightening towards said tail (18);
two wings (24) mounted on opposite sides of said fuselage (12);
two engines (22), each said engine (22) mounted on a pylon (26) on a respective side of said fuselage (12);
two propellers (28), each said propeller (28) joined to and positioned behind a respective said engine (22);
at least one cabin door (32) to access said cabin (14); and
landing gear (60);
wherein said engines (22) are positioned above said wings (24);
wherein said propellers (28) are positioned at a rear end of each said engine (22) such that said propellers (28) push said engines (22);
wherein said propellers (28) are positioned behind the inhabitable zone of said cabin (14); and
wherein said wings (24) each comprise at least an inner wing section (54) and an outer wing section (56), each said inner wing section (54) comprising a stronger dihedral angle than each said outer wing section (56).

43. The aircraft of claim 42, wherein each said inner wing section (54) is stiff and each said outer wing section (56) is flexible and bends during flight.

44. The aircraft of claim 42, wherein each said inner wing section (54) terminates at a plurality of attachment points (58) for said landing gear (60), and said fuselage (12) further comprises landing gear compartments (62) for storing said landing gear (60) such that said landing gear (60) is retractable.

45. The aircraft of claim 44, wherein said landing gear compartments (60) are watertight.

46. The aircraft of claim 42, wherein said inner wing sections (54) cross through the aircraft (10) under at least one seat (66) inside said cabin (14).

47. The aircraft of claim 42, wherein the dihedral angles of said inner wing sections (54) are strong enough such that said outer wing sections (56) stay above the water.

48. The aircraft of claim 42, wherein said inner wing sections (54) comprise at least one of floats or sponsons.

49. The aircraft of claim 42, wherein said outer wing sections (56) comprise floats.

50. The aircraft of claim 42, wherein the propellers (28) are positioned above the wings (24).
